(19) United States
(12) Patent Application Publication
(10) Pub. No.: US 2017/0228727 A1
(43) Pub. Date: Aug. 10, 2017

(54) CONDITIONAL PAYMENT PROCESSING USING MULTI-SIGNATURE ADDRESSES

(71) Applicant: Align Commerce Corporation, San Francisco, CA (US)

(72) Inventors: Marwan Forzley, Sausalito, CA (US); Aldo Mario Eduardo S. Carrascoso, Daly City, CA (US)

(21) Appl. No.: 15/040,498

(22) Filed: Feb. 10, 2016

(51) Int. Cl. G06Q 20/38; H04L 29/12; G06Q 20/06; H04L 9/08

(52) U.S. Cl. CPC G06Q 20/3829; H04L 9/0838; H04L 9/0861; H04L 61/35; G06Q 20/3823; G06Q 20/3825; G06Q 20/065

(57) ABSTRACT

Payment processing policies for implementing using multi-signature addresses includes defining an address associated with the multi-signature addresses and generating a plurality of keys and associating them with each of the addresses. For each of the plurality of keys one or more rules is defined that when triggered enable each of their corresponding plurality of keys to be signed. Each rule is a logical combination of one or more conditions and each of the one or more conditions has one or more attributes that when true allow each of the conditions to be true. A number of keys must be signed in order to unlock each address. One or more exit rules may be defined associated with each address where if not all of the plurality of keys have been signed before the exit rule is triggered then all of the plurality of keys are reset to an unsigned state cancelling the transaction.

### FIELD OF THE INVENTION

The present invention is related to the use of encryption keys to process conditional payments.

### DESCRIPTION OF THE RELATED ART

Payments can be made from a payer to a payee for various reasons. A consumer may purchase goods or services from a merchant in person, via telephone or through an Internet web site. A merchant or business may be paying a supplier, employees, sales staff, consultants, or others. They may also be issuing refunds or rebates to customers or suppliers, or making payments as part of an affiliate program with another business or individual. Businesses may be paying salaries to employees or consultants on a reoccurring or one-time basis. There are a number of other situations where an individual will be transferring currencies to an associate or family member in another country. Payments may be small or large, and completion of the payment may be required quickly or to be completed at a specific time, for example, at the end of the business day in a particular time zone. Payments may be made in the same or different currencies.

Digital or crypto-currencies have been developed that can be used to provide payment for goods and service and be used by both payers and payees and be used for both domestic and international transfers, payments and exchanges. Crypto-currencies are a medium of exchange designed around securely exchanging information and value. A crypto-currency can be centralized or decentralized. Crypto-currencies may take the form of digital data but may also may be physically represented by cards or printed paper.

Public-private key pairs are used to ensure the security of crypto-currencies. Public and private key pairs together, separately and individually are used to sign transactions, crypto currencies or other related ecommerce transactions in order to unlock value or show ownership of a particular crypto currency, transaction or combination thereof.

Keys may be simple or complex and the more complex the key and its associated management and application, the more secure the use of crypto-currencies. Addresses are used to refer to public keys, which must be combined with their private keys to access the crypto-currency. To access a crypto currency transaction containing a specific amount of crypto currency a single or combination of public-private key pairs is required.

In order to use a crypto-currency for a financial transaction it is typically stored in a digital or offline wallet. Crypto-currency wallets are associated with addresses that act as a locator to the wallet to allow depositing and withdrawing from the wallet. Private keys are used to access the wallet addresses.

Private keys are used to sign a multi-signature address which then causes the payment to be released to the receiver or back to the sender. In traditional payments, multi-signature addresses are merely proxies to existing payment types such as cards, bank accounts, wallets, gift cards or other forms of payments.

### BRIEF SUMMARY

In a first embodiment of the invention, a process for generating a multi-signature address comprises defining an address associated with said multi-signature address and generating a plurality of keys and associating them with the address. For each of the plurality of keys, one or more rules are defined that when triggered enable each of their corresponding plurality of keys to be signed. Each of the one or more rules is a logical combination of one or more conditions, where each condition has one or more attributes that when true allow each of the conditions to be true. The number of keys that must be signed in order to unlock the address is also defined. One or more exit rules may be defined associated with each address where if not all of the plurality of keys have been signed before the exit rule is triggered, then all of the plurality of keys are reset to an unsigned state cancelling the transaction.

In another embodiment of the invention, a multi-signature address is received and a plurality of keys is determined from the address. The number of the plurality of keys that must be signed in order to unlock said address is also determined. At least one rule associated with at least two of the plurality of keys is determined. One of said at least two of the plurality of keys is signed after waiting until the at least one condition occurs. At least one condition having one or more attributes that when true allow said at least one condition to be true. The address is unlocked when the required number of the plurality of keys are signed.

In a further embodiment of the invention, a multi-signature address has an address associated with it and a plurality of keys are associated with the address. For each of the plurality of keys, there are one or more rules that when triggered enable each of their corresponding plurality of keys to be signed. Each of the one or more rules is a logical combination of one or more conditions and each of the one or more conditions have one or more attributes that when true allow each of said conditions to be true. A number of the plurality of keys that must be signed in order to unlock said address. One or more exit rules may be associated with the address wherein if not all of the plurality of keys have been signed before the exit rule is triggered then all of the plurality of keys are reset to an unsigned state.

Yet another embodiment of the invention involves a method for implementing a policy for financial transactions involving a merchant, a consumer, and a payment processor. A plurality of multi-signature addresses are defined and addresses associated with each of said plurality of multi-signature addresses are defined. A plurality of keys are associated with each of said address. For each of the plurality of keys, one or more rules are defined that when triggered enable each of the corresponding plurality of keys to be signed. The one or more rules are a logical combination of one or more conditions, where the one or more conditions each have one or more attributes that when true allow each of the conditions to be true. A number of the plurality of keys that must be signed in order to unlock the addresses. The financial transactions may utilize crypto-currencies. The number of keys that must be signed to unlock the addresses, the rules, the conditions, and the attributes may be defined by the consumer, the merchant, or the payment processor.

Payment processing policies for implementing using multi-signature addresses includes defining an address associated with the multi-signature addresses and generating a plurality of keys and associating them with each of the addresses. For each of the plurality of keys one or more rules is defined that when triggered enable each of their corresponding plurality of keys to be signed. Each rule is a logical combination of one or more conditions and each of the one or more conditions has one or more attributes that when true allow each of the conditions to be true. A number of keys must be signed in order to unlock each address. One or more exit rules may be defined associated with each address where if not all of the plurality of keys have been signed before the exit rule is triggered then all of the plurality of keys are reset to an unsigned state cancelling the transaction.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is a block diagram illustrating a hierarchy of policies, multi-signature addresses, keys, rules, conditions, and attributes.

FIG. 2 is a diagrammatic illustration of examples of rules, conditions and attributes.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

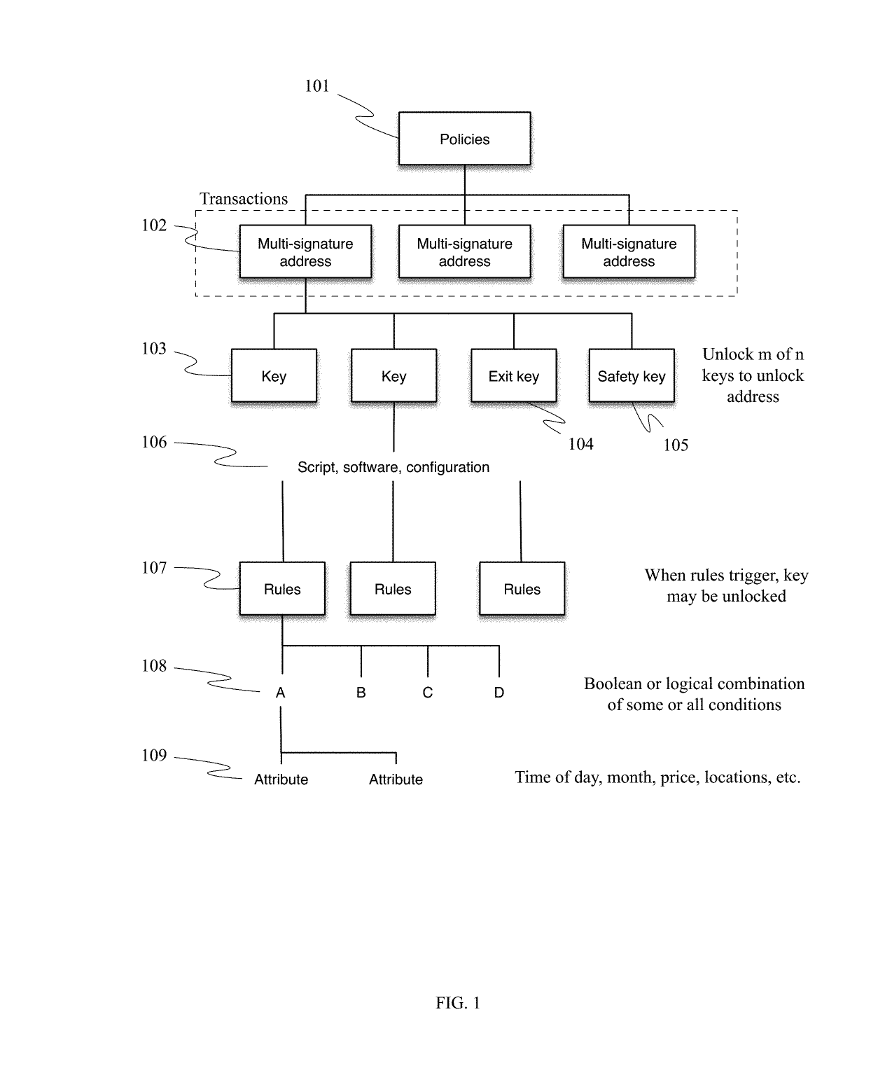

FIG. 1 illustrates how security policies 101 can be implemented using one embodiment of the invention. Multi-signature addresses 102 provide security for access to crypto-currencies for secure storage or transactions. A multi-signature address is an address that is associated with more than one public-private key pair 103. One of the simplest form of multi-signature address 102 is an m-of-n address and is defined by the variables m and n, where n is the total number of public-private keys associated with generating a multi-signature address 102 and m is the number of private keys that must be signed in order to unlock the address associated with the crypto-currency. In FIG. 1 it can be seen that n is 2. It can be seen that m is less than or equal to n. If sending crypto-currency from a wallet that is associated with n private keys, then sending crypto-currency from this address requires signatures from at least m keys. A multi-signature transaction is one that sends and receives funds from a multi-signature address.

Using an m-of-n multi-signature address 102 allows the n keys to be kept in multiple location, on multiple computer systems, with multiple computer operating systems even in non-digital and offline locations such as in paper or in paper wallets. The key can be managed and administered using separate applications as well. Since m of the total keys must be compromised in order to unlock the value assigned to a transaction unlocking the multi-signature address becomes more difficult than the case of a single signature which has only a single key.

M-of-n multi-signature addresses 102 also provide redundancy. For example, with a 2-of-3 address, the crypto-currency owner can still unlock the value if they forget any single key provided they have at least 2 of the 3. Multi-signature addresses 102 may also be shared among multiple people where a majority vote or a defined number of votes are required to unlock and use the funds. Another embodiment of multi-signature addresses involves a party such as a payment processor setting up, tearing down, configuring, and processing multi-signature addresses and transactions involving multi-signature addresses.

To set up a multi-signature address 102 the payment processor creates the multi-signature address with a plurality of keys 103. Each key 103 may be labeled and named by the payment processor or user for reference. Each key 103 is also programmed or configured by linking it to a script, software, or configuration 106. Each script defines a number of conditions 108, attributes 109, and rules 107. The script or the software 106 can be resident on a payer's computer, server, digital storage, cloud locations or mobile device. The script 106 could also be resident on servers, or computers or mobile devices operated by the payment processor or another third party. The script 106 includes one or more rules 107 that must trigger to enable a key 103 to be signed. If the key 103 is triggered, then it becomes “active” and is able to be signed in order to approve a transaction. Each rule 107 defines a Boolean combination of conditions 108 that must occur for the rule 107 to be triggered. For example, given four conditions 108 labeled A, B, C and D, one rule 107 may be triggered if conditions 108 A, B and D occur, whether C occurs or not. Another example would be to trigger the rule 107 if B and C occurred but not D. A further example would be to trigger a rule 107 if any 3 of conditions A, B, C or D occur.

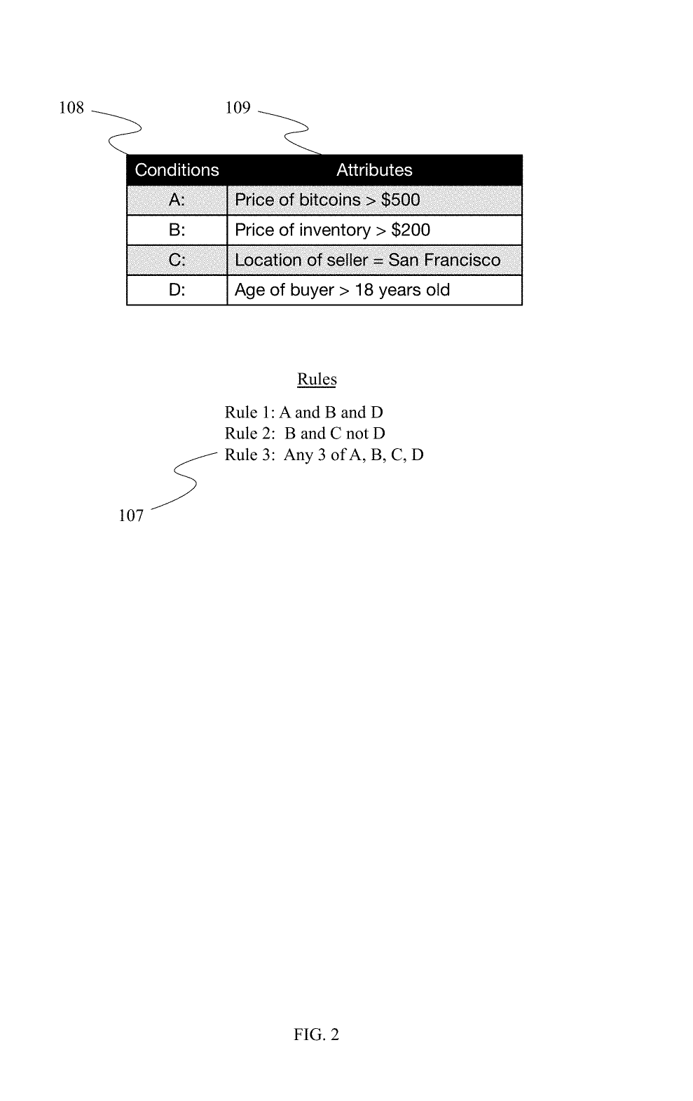

Referring to FIG. 2, conditions 108 are comprised of one or more attributes 109 such as if the price of bitcoins is greater than $500. the price of inventory is less than $200, a seller is located in a specific location such as San Francisco, or the age of a buyer over 18 years of age or any number of other attributes 109 agreed upon by the payment processor, the merchant, the consumer, the payer, the payee, or other involved parties. For rules 107, conditions 108, and attributes 109 other combinations and combinations can be defined depending on the level of complexity desired and the level of security required. A “safety key” 105 may also be defined which would allow for the unlocking of an escrow or a disputed transaction. It could also be used when private keys have been lost. Also part of the configuration script 106 is that the payment processor can setup an “exit key” 104; a time based rules or any other type of rules to exit or cancel a multi-signature transaction and return the funds to their owner or another action. The attributes 109, conditions 108 and rules 107 for the exit rule 104 may be setup in situations where the triggering of the events that are designed to activate the keys have not occurred and where a time limit has expired. An example is that if the multi-signature address 102 is configured where the private key 103 is activated if the price of the good goes down by 5% for a period no more than 24 hours, then at the expiry of the time period, the transaction expires and the funds are returned to their owner. The exit rule 104 conditions could be time based, event based, payer based, payee based, or enforced by the payment processor based on its policies or requests by banks, government agencies or any other entity that has the ability to force the address to expire.

Further examples of attributes 109 include but are not limited to:
Time field: Key is activated after midnight.
Date: Key is activated after Jan. 1, 2020.
Location: The key is activated only if the payer is in California.
Identity: The key is activated based on the identity of the payer on a national or state driver's license.
Price of a good or service: The key is activated if the price of the good is over specified amount or the price of this service declines to below a specified price.
Price of currency: The key is activated if the price of a crypto-currency is over a specified amount or the price of a fiat-currency is over a specified amount.
Database entries: The key is activated if there is an entry in a database. For example, the key is activated if the payer is in the customer database.
Any information that can be used as input to the script. For example, the key can be activated if the weather in New York is above 50 degrees Fahrenheit or if the result of the presidential election were in favor of candidate A.

Functions that scripts 106 can be used for multiple aspects of a multi-signature key system including but not limited to the following:
Creation of key pairs
Script that automates key pair generation or creation
   Storage location of keys
Script that auto routes key pairs to final management/storage destination
   Routing to 3^{rd} party management—key holders
   Routing to payment processor server
   Routing to Mobile devices
   Routing to Local machine storage, including hard disks and solid-state drives
   Routing to Web browser storage
   Routing to other forms of online, digital storage such as flash drives
   Routing to other forms of offline storage including automatically printing on paper wallets
Management and Administration
   Script that retrieves keys from various locations based on conditions
   Script that returns unspent transactions to originator
   Script that checks for unused or undocumented addresses with balances
   Script that empties and deletes obsolete addresses
Transaction Automation
   Script that allows for automated remote signing. For example, through email or through a dashboard application,
   Script that automates key importing from digital or offline locations either remotely or locally from the server executing the transaction,
   Script that automates key pair raw extraction
   Script that automates private key signing o Script that automates raw transaction creation
   Script that automates transaction sending
   Script that automates transaction sending
Security
   Script that automates backing up (redundancy) of keys

Keys may be generated by any number of electronic devices including servers, computer, tablets, cell phones. Keys may be supplied or partially supplied by the user, the payment processor, or by a financial institution such as a bank or currency exchange. The keys may be stored on a user's own device and may be stored in a database. When stored in a database, an application can be authorized to access the key from the database. Keys may be split and stored in a number of locations, for example partially on a user's device, with a payment processor, or with a financial institution such as a bank or currency exchange.

A multi-signature address 102 can also function as a unique identifier that abstracts traditional payment types including: wallets, cash, cards, bank, prepaid cards, gift cards, voucher cards, voucher pins, or any other form of eMoney. When all the conditions 108 are met and the payment is executed, the multi-signature address becomes the trigger for the payment action. For example, once conditions are met, credit cards are charged, funds pushed or pulled from bank accounts, funds released from escrow, cash exchanged or moved into electronic wallets, gift cards exchanged for inventory, vouchers applied and executed. The same logic and actions that apply to crypto-currency are applicable for traditional payments and the address acts as a proxy, or a representation of the action required from traditional payments.

A set of rules 107 on a network can define the behavior of payments inside the network. Therefore, it is feasible to setup operating policies 101 on the network comprising of a set of rules 107 and conditions 108 administered on a set of multi-signature addresses 102 thereby determining and influencing the behavior of transactions; what gets accepted and what gets declined.

E-Commerce and financial service providers can incorporate multi-signature keys for conducting currency exchanges within or between countries, to purchase items, issue invoices, to pay employees and a variety of other uses. Currency exchanges can be from a national or fiat currency to a crypto-currency such as Bitcoin or the reverse, from a crypto-currency to a fiat currency. The transfer of currencies can be between the same currency or between different currencies. Service providers may integrate multi-signature technology into a web-based user interface using APIs (application programming interfaces). A payment processor is a company or organization that provides the software and infrastructure to do currency exchanges using multi-signature keys. A plugin can be created by the payment processor to allow people to collect payments through their website in different crypto and fiat currencies. The plugin provided by the payment processor provides a payment gateway that may be branded by either the service provider or the payment processor. A user must enter identification and bank account information after which the payment proceeds in a similar way to paying online using a credit card or PayPal. The Payment processor is responsible for checking and verifying the user's identity including name, address and any other required information required to verify their identity.

One feature of this system is the service provider (merchant or financial institution) is not required to assume the risk of a fraudulent transaction. This is assumed by the payment processor. The plugin uses a software module called a “risk engine” that will confirm the user data and combine it with attributes of the transaction to evaluate the risk of the transaction to determine the complexity of the multi signature key to be used. Transaction attributes can include the identity and payment history of the payer and payee, the source and destination country of the transaction, the fiat or crypto currencies involved and their amount, the risk tolerance of merchants, financial institutions, currency exchanges, and governments involves, and a variety of other factors. The risk engine allows the user to enter the required information to evaluate the transaction and if it determines that it is a high-risk transaction may stop the transaction, and require additional information or require manual intervention.

The payment processor will evaluate the multi signature key and sign them, thereby assuming the risk for the transaction.

The merchant, financial exchange, currency exchange, or other involved party may configure the level of risk they are willing to accept using a software module referred to as the “business configuration engine.” This can be used to specify the parameters of the multi signature key such as the number of keys, number of rules, scripts, conditions, and attributes.

Advanced currency exchange features may be implemented by the plugin such as creating queues for each source and destination currency exchange and only triggering the actual conversion when a predefined exchange rate is met. This can be implemented using multi-signature keys by defining an additional key where the rule includes a condition where the attribute is the desired exchange rate. Note that if the condition is never met some conversions may take a long time or may never trigger. In this case an exit key containing a rule with a condition using an attribute of the pendency of the transaction can be used to automatically cancel the transaction or notify the payee or payer.

Many international transactions will use a plurality of conversions such as from one fiat-currency to an intermediate crypto-currency, and another one from the crypto-currency to a second fiat-currency. For this type of two-leg or multi-legged transaction a different multi signature key can be used for each leg with each key having its own set of keys, rules, conditions, and attributes.

The payment processor has its own risk engine to determine the parameter of the multi signature key and therefore may assume the risk of the transaction. However, in some embodiments of the invention the evaluation by the risk engine and the responsibility may be bourn by third party insurance companies.

In another embodiment of the invention, companies, merchants, financial institutions, insurance companies and other parties may utilize multi signature keys to implement a manual authorization system for high risk or high value transactions. This can be done by defining a manual key in each multi signature address that must be entered by an individual in the organization to approve the transaction. The manual key may involve entering data through a user interface device such as a keyboard, a scanned signature, biometric information such as a finger print or iris scan, or inserting a specially prepared USB key, SD card, NFC device or similar non-volatile memory device. For example, in a company the finance manager may be able to approve most transactions immediately but transactions over a specified amount are queued until the CEO or CFO inserts a USB key into a computer or terminal or accesses the payment processor's website using a specific laptop, computer, or mobile computing device. The private manual key stored on a USB key or electronic device does not have to be the actual key but may be a hash of the key. A similar setup may be used by police to release confiscated funds, a parent to approve purchases made by their children over a predefined amount, or customs officials when currency limits are exceeded. In larger organizations there may be a large number of private USB sticks containing private manual keys to approve large transactions. These may be distributed to the officers of the company and large transactions may be signed and approved by using a subset of the distributed keys. For example, a bank may have a special authorization key with 3 USB sticks required from a total of 10 officers of the bank to approve the transaction.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A process for generating a multi-signature address comprising:
defining an address associated with said multi-signature address;
generating a plurality of keys and associating said keys with said address;
for each of said plurality of keys, defining a rule that when triggered enables each of said corresponding plurality of keys to be signed, said rule being a logical combination of a plurality of conditions, said plurality of conditions each having an attribute that when true allows each of said plurality of conditions to be true; and
defining the number of said plurality of keys that must be signed in order to unlock said address.

2. The process of claim 1, further comprising determining one or more exit rules associated with said address wherein if not all of said plurality of keys have been signed before said exit rule is triggered, then all of said plurality of keys are reset to an unsigned state.

3. A process for signing a multi-signature address comprising;
receiving an address;
determining a plurality of keys from said address;
determining a number of said plurality of keys that must be signed in order to unlock said address;
determining a rule associated with at least two of said plurality of keys;
waiting until said a condition occurs before signing one of said at least two of said plurality of keys, said condition each having an attribute that when true allow said condition to be true;
unlocking said address when said number of said plurality of keys are signed.

4. The process of claim 3, further comprising determining an exit rule from said address wherein if not all of said plurality of keys have been signed before said exit rule is triggered then all of said plurality of keys are reset to an unsigned state.

5. A method for implementing a policy for financial transactions involving a merchant, a consumer, and a payment processor comprising;
defining a plurality of multi-signature addresses;
defining addresses associated with each of said plurality of multi-signature addresses;
generating a plurality of keys associated with each of said addresses;
for each of said plurality of keys, defining a rule that when triggered enable each of said corresponding plurality of keys to be signed, said rule being a logical combination of a plurality of conditions, said plurality of conditions each having an attribute that when true allow each of said plurality of conditions to be true;
defining the number of said plurality of keys that must be signed in order to unlock said address.

6. The method of claim 5, wherein the financial transaction utilizes cryptocurrencies.

7. The method of claim 5, wherein at least one of said plurality of keys, said rules, said conditions, and said attributes are defined by said consumer.

8. The method of claim 5, wherein at least one of said plurality of keys, said rules, said conditions, and said attributes are defined by said merchant.

9. The method of claim 5, wherein at least one of said plurality of keys, said rules, said conditions, and said attributes are defined by said payment processor.

10. The method of claim 5, wherein said multi-signature address is an identifier for non-digital payment types.
